(19) United States
(12) Patent Application Publication
(10) Pub. No.: US 2006/0030795 A1
(43) Pub. Date: Feb. 9, 2006

(54) System and method of moderation of vestibular disorders

(75) Inventors: Timothy E. Luberski, Fullerton, CA (US); Lee A. Samango, San Diego, CA (US)

Correspondence Address: Crockett & Crockett, Suite 400, 24012 Calle De La Plata, Laguna Hills, CA, 92653, US

(73) Assignee: SportKAT, LLC

(21) Appl. No.: 10/911,452

(22) Filed: Aug. 3, 2004

(51) Int. Cl. A61H 1/02

(52) U.S. Cl. 601/1

(57) ABSTRACT

A system and method for use in moderating symptoms associated with vestibular disorders. The patient stands atop a balance platform and balances or performs other exercises on the platform. The exercises require the patient to work against the instability of an inflatable bladder positioned beneath the balance platform. Training difficult may be increased or decreased by changing the pressure of the inflatable bladder. Increased pressure makes the bladder firm, which is easier to balance upon and decreased pressure softens the bladder, making it more difficult to balance upon. Over time, the repeated performance of the exercise sessions improves the impairment the patient is experiencing due to the symptoms of the vestibular disorder.

### FIELD OF THE INVENTIONS

The inventions described below relate the field of moderation of symptoms associated with vestibular disorders caused by endolymphatic hydrops, vestibular neuronits, migraines, trauma, toxic agents, infectious agents and motion sickness in addition to devices used to improve the quality of life of patients with multiple sclerosis, Parkinson's Disease, cerebellar degeneration, and Amyotrophic Lateral Sclerosis (ALS).

### BACKGROUND OF THE INVENTIONS

Balance training systems have been around for several years. For example, the system disclosed in Mason et al., Kinesthetic Diagnostic and Rehabilitation Device, U.S. Pat. No. 5,112,045 describes a kinesthetic diagnostic and rehabilitation device. These devices have been utilized for measuring the extent of kinesthetic impairment resulting from a bodily injury. This system uses a rigid platform positioned on top of an unstable support. The patient engages in exercises that require the patient to maintain a fixed position on the platform as a function of instability of the unstable support. Over time, these exercises result in the patient's kinesthetic improvement. The entire disclosure of the '045 patent is herein incorporated by reference.

Symptoms of vestibular disorders have traditionally been treated with drugs. Recently we have discovered that the use of balance training systems on patients with vestibular disorders effectively and drastically improves the degenerative symptoms associated with the disorders. We propose treating symptoms of patients with vestibular disorders with balance training systems in order to decrease the severity of the symptoms and improve the quality of life.

### SUMMARY

The method described below employs the use of an inflatable device described in Mason et al., Kinesthetic Diagnostic and Rehabilitation Device, U.S. Pat. No. 5,112,045, and similar devices in conjunction with a balance platform, a bladder, a monitor and a control system for moderation of symptoms associated with vestibular disorders. A patient desiring to moderate his symptoms engages in a regimen using the vestibular diagnostic and rehabilitation device. The patient stands atop the platform and balances or performs other exercises for a number of predetermined sessions. The system directs the patient to manipulate the platform with his body movement to cause corresponding manipulation of a cursor element on the monitor display. The patient manipulates the cursor to trace shape patterns, move through mazes, perform sports related tasks, or moving through Pac-Man™ like mazes presented on a monitor that the patient views, using the balance platform as a joystick. The complexity of the patterns, mazes, or sports related tasks may be increased or decreased over a course of treatment comprising multiple sessions spread over several weeks. The treatment is effective to reduce the symptoms associated with vestibular disorders.

The exercises require the patient to work against the instability of the inflatable bladder. Training difficultly may be increased or decreased by changing the pressure of the inflatable support bladder. Increased pressure makes the bladder firm and therefore easier to balance upon. Decreased pressure softens the bladder and therefore more difficult to balance upon. Over time, the repeated performance of the exercises reduces the impairment the patient is experiencing due to the symptoms of vestibular disorders.

When used to treat symptoms of vestibular disorders, many treatment sessions, spread out over several weeks are used. A full course of treatment usually consists of 20-30 daily sessions for intervals of approximately 15-20 minutes per session. The treating physician would then make a determination whether a further course of treatment is necessary.

### BRIEF DESCRIPTION OF THE DRAWINGS

FIG. 1 illustrates the balance training system used by the patient.

FIG. 2 illustrates a view of the monitor display prompting a user to select an activity;

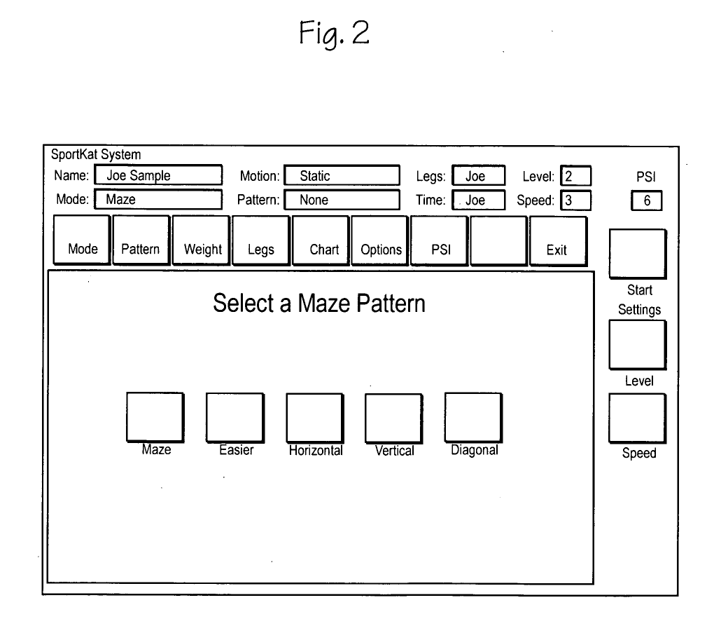

FIG. 3 illustrates a view of the monitor display of a static training mode session;

FIG. 4 illustrates a view of the monitor display of a certain maze pattern;

FIG. 5 illustrates a view of the monitor display of an easier maze pattern;

FIG. 6 illustrates a view of the monitor display of a horizontal maze pattern;

FIG. 7 illustrates a view of the monitor display of a vertical maze pattern;

FIG. 8 illustrates a view of the monitor display of a diagonal maze pattern; and

FIG. 9 illustrates a view of the monitor display of the graph mode.

### DETAILED DESCRIPTION OF THE INVENTIONS

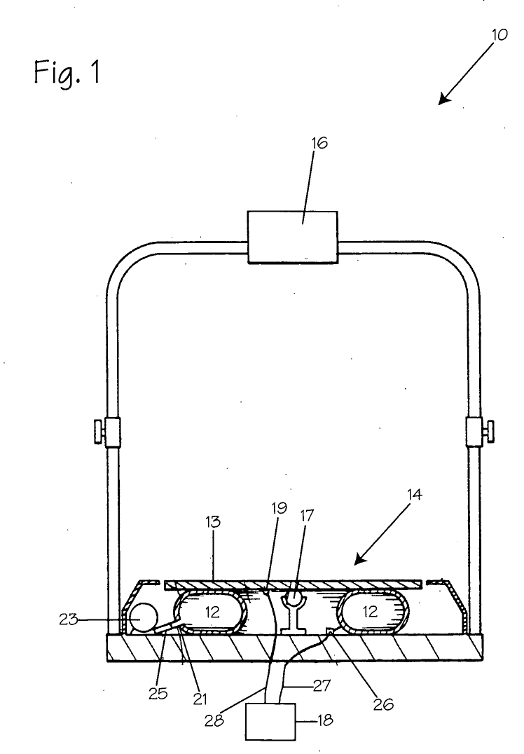

FIG. 1 illustrates the balance training system 10. The balance training system 10 comprises an inflatable bladder 12, a balance platform 14 comprising a platform disk 13 and a bladder, a monitor 16, a control system 18, and a tilt sensor 19. The balance platform 14 rests atop of the inflatable bladder 12. The balance platform 14 is sized and dimensioned to accommodate an adult patient standing on the top of the platform. The system may also have a pivot 17 located under the platform 14 to assist the bladder in providing varying degrees of stabilizing support beneath the platform 14. This assists the patient in maintaining his position on the platform 14 surface.

The balance training system contains a bladder 12 positioned beneath the centrally pivoted platform disc 13 that provides variable stability to the balance platform 14. The pressure in the bladder 12 can be adjusted according to training criteria or user preference. The pressure range in which the bladder is operable is between about 0 and 15 psi, preferably between 0 and 6 psi. The bladder has a valve 21 which is operable to change the pressure of air in the bladder. The valve provides for either inflating the bladder by adding air to it or deflating the bladder by withdrawing air from it. The training difficulty may be increased or decreased by adjusting the pressure in the bladder. Increased pressure makes the bladder firm, making the platform easier to balance on. This firm setting may be introduced in the early training sessions to allow the patient to get used to the balance system. As the patient improves and his symptoms diminish, the pressure in the bladder may be decreased to soften the bladder, making it more difficult to balance upon. The decreased pressure results in patients' improvement in neurosensory or balance deficits, increases patient strength, develops dynamic balance, muscle control, proprioceptive and vestibular improvement. A pressure adjustment means is provided, such as a pump or compressor 23. The pressure adjustment means is in fluid communication with the bladder via line 25. The pressure adjustment means can be adjusted by the physician or patient prior to beginning any exercise session. A pressure transducer 26 is also used to communicate pressure variations from the bladder 12 to the control system 18 via line 27.

The balance training system also contains a tilt sensor 19 for sensing the attitude of the platform. The tilt sensor is positioned on the top of the platform 14. The tilt sensor can be any sensing means such as an inclinometer, an accelerometer, an array of encoders dispersed around the platform, a gravitational sensor, or any other suitable means for sensing the attitude of the platform. The tilt sensor 19 is in electrical communication with the control system 18 via line 28. The tilt sensor measures the attitude of the platform and sends a corresponding signal to the control system 18. This data is analyzed to produce a record of the patient's movements for analysis by a physician and is used to represent platform attitude as in a display on the monitor 16.

The control system 18 of the system is operable to process all of the data it acquires in a manner which provides meaningful feedback information to the treating physician or patient. The control system receives input from the tilt sensor and interprets the input as indicating the attitude of the patient's position on the balance platform. The control system also receives input from the patient or user regarding the desired modes, manners and other settings for use of the balance training system.

The monitor of the system works in conjunction with the control system to display input received from the control system. The data regarding the attitude is sent to the monitor, which generates images or displays of the attitude on the monitor for the patient to view. The monitor is also operable to work in conjunction with the control system to generate the images or displays for the patient to view while engaging in an exercise session using the balance control system. According to the modes, manners and settings the patient has input into the control system, predetermined images are displayed onto the monitor. These images instruct the patient how to manipulate the balance platform with his legs, shifting his weight as necessary to affect motion of the graphic element or image on the display.

In use, a user begins by standing on the balance platform of the balance training system and initiating the monitor 16 and control system 18. Information regarding the patient's age, height, and weight are input into the control system in order to set up the balance training system. The user is then prompted to select from one of several different modes, patterns, and other settings. According to the settings selected, the user then engages in exercises involving manipulation of the balance platform by shifting the weight in his legs. The control system is operable to provide displays on the monitor for the user to view in order to manipulate the display according to the platform attitude.

The settings for the exercise settings require several different inputs by the user. The monitor prompts the user to adjust the amount of pressure contained in the bladder. The bladder pressure ranges from 0 to 15 psi, preferably between 0 and 6 psi. A lower bladder pressure provides for greater instability of the bladder and platform. A higher bladder pressure provides for a more stable bladder and platform. Typically patients with more severe symptoms initially set the pressure setting closer to 6 psi to provide a good balance between stability and resistance. The selected pressure is generally one which at least somewhat destabilizes the platform and causes the patient to work kinesthetically in maintaining the position of the platform surface to offset the instability of the bladder. The monitor also prompts the user to input a foot pattern in that the patient may either use his left foot only, his right foot only, or both feet simultaneously to manipulate the platform. Additionally, the monitor prompts the user to enter a time interval for the exercise session.

The user must select from one of the following desired modes: 1) maze; 2) review; 3) test; or 4) training. If the user selects the maze, test, or training mode, he must further select the desired manner for these modes. Any of these modes must be performed in one of the three following manners: 1) static; 2) dynamic move; or 3) dynamic. A patient views a cursor or graphical element on the display monitor. Graphically this cursor is represented by an “X” on the monitor. The cursor is a visual representation on the monitor of the patient's body movements. As the patient moves, the cursor on the monitor moves in a corresponding submode.

In a static submode, the patient attempts to maintain his body position on the balance platform such that the X cursor is centered on the display monitor throughout the entire exercise interval.

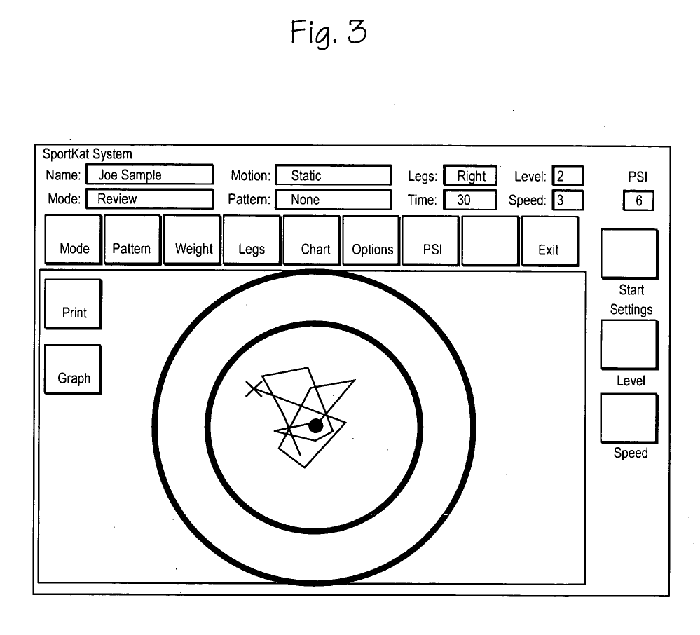

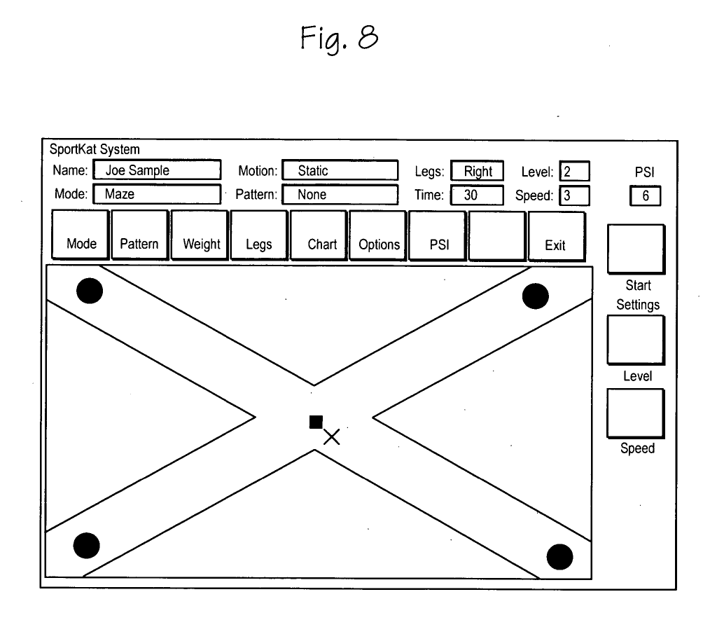

FIG. 3 illustrates the display viewed by a patient on the monitor during a static submode exercise session. The goal of the dynamic submodes is to engage the user in a series of exercise sessions where the balance platform is used as a joystick. The user either traces a pattern or moves through a series of Pac-Man™ type games in order to complete the exercise session. In the dynamic pattern submode, the patient attempts to manipulate the cursor along the outline of a selected pattern in order to trace the pattern. The pattern may be any of the following: a circle (clockwise or counterclockwise); a square (clockwise or counterclockwise); a cross; a FIG. 8; or an infinity symbol.

In the dynamic submode, the patient views both the cursor on the monitor as well as a square icon. The patient attempts to manipulate the cursor in different ways with his body position. The cursor is manipulated so that it is positioned over the square icon and then moves the square icon. The square icon is moved throughout a series of mazes or other activities that appear on the monitor. Each activity contains paths and obstacles. Contained within the obstacles of the configuration are circle icons. The patient manipulates the X cursor over the square icons in order to “pick up” and “move” or “drag” the icons through the maze and on top of the circle icons. Once the square icon has been positioned over the circle icon, the circle icon is considered captured and the patient may then move on to capturing the other circle icons. Once all of the circle icons have been captured, the maze is completed and the session time is recorded and used for assessment of improvement by the physician or therapist.

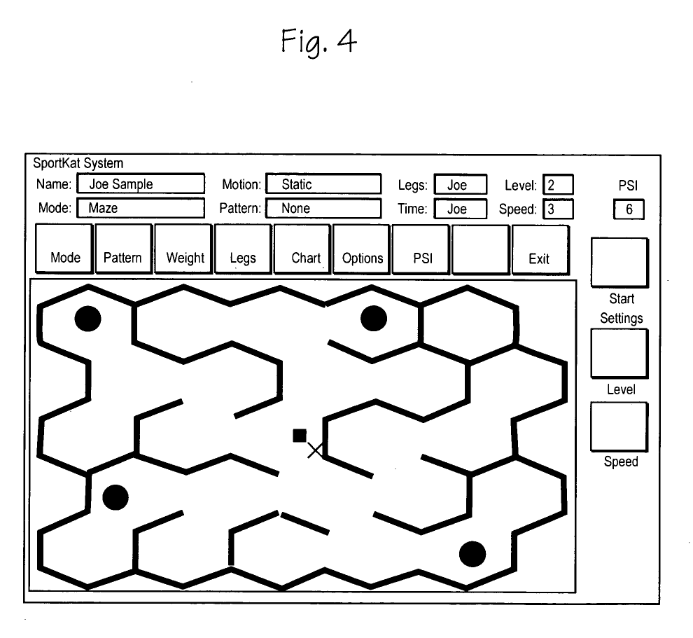

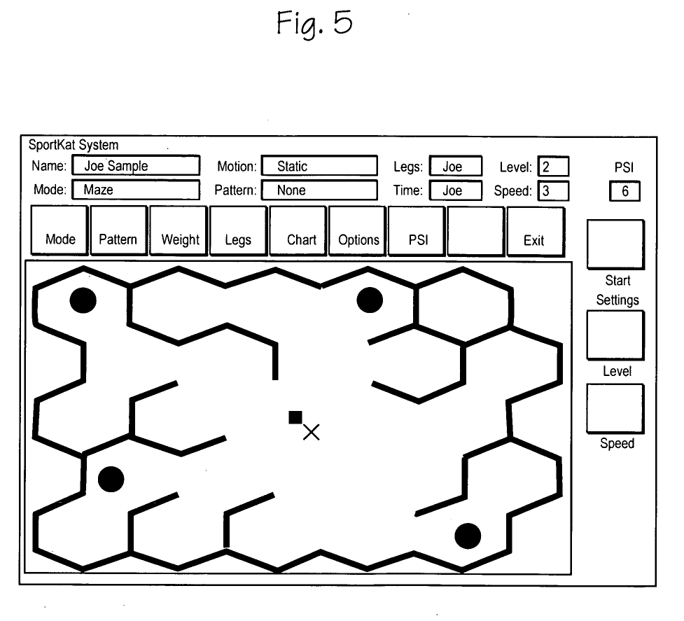

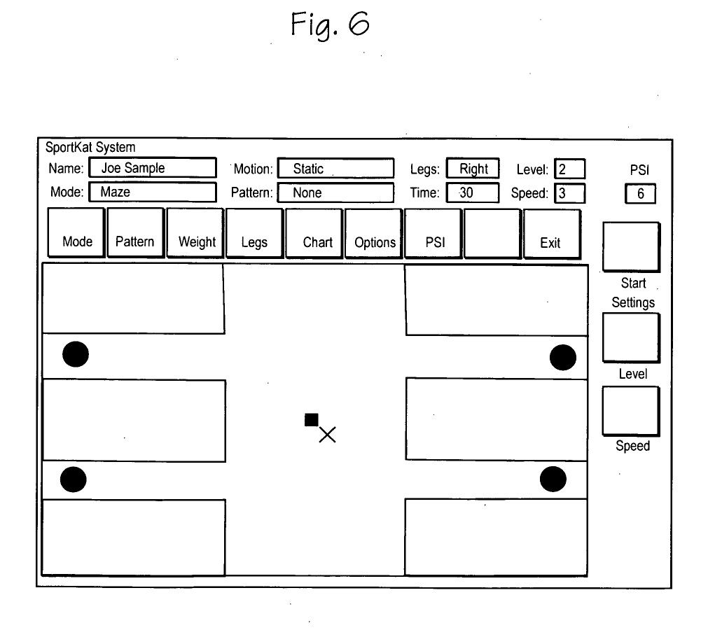

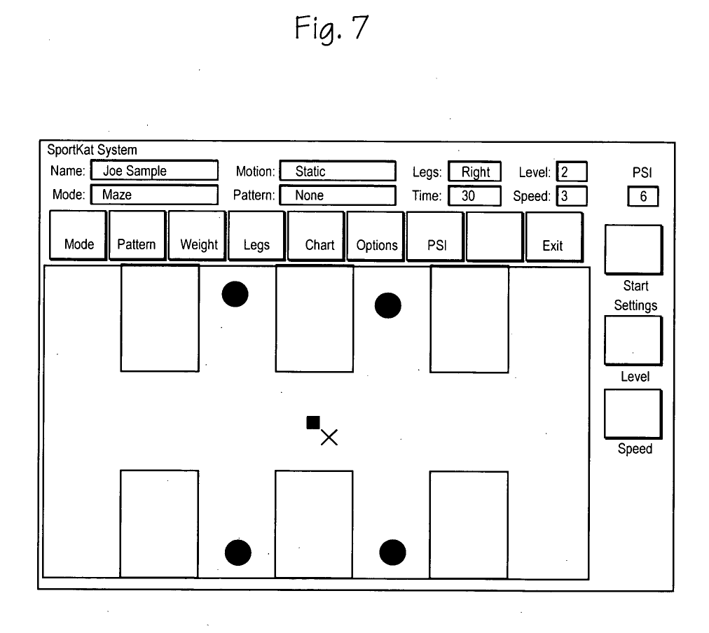

FIGS. 4 through 8 illustrate different mazes that may be selected for use by the patient in the dynamic submode. FIGS. 4 and 5 illustrate mazes that contains a honeycomb pattern with circles positioned within the honeycomb pattern. FIG. 6 illustrates a maze pattern that contains horizontal block obstacles with circles positioned between the obstacles. FIG. 7 illustrates a maze pattern that contains vertical block obstacles with circles positioned between the obstacles. Finally, FIG. 8 illustrates a diagonal maze pattern where the circles are positioned at the corner of each diagonal. The goal with each of these mazes is to have the patient manipulate the X cursor over each of the square icons. The patient then “picks up” the square icon and “moves” or “drags” it through the maze to capture the circle icons. Each maze requires different steps of manipulation by the user because each maze has different obstacles prevent certain types of movement of the square icon.

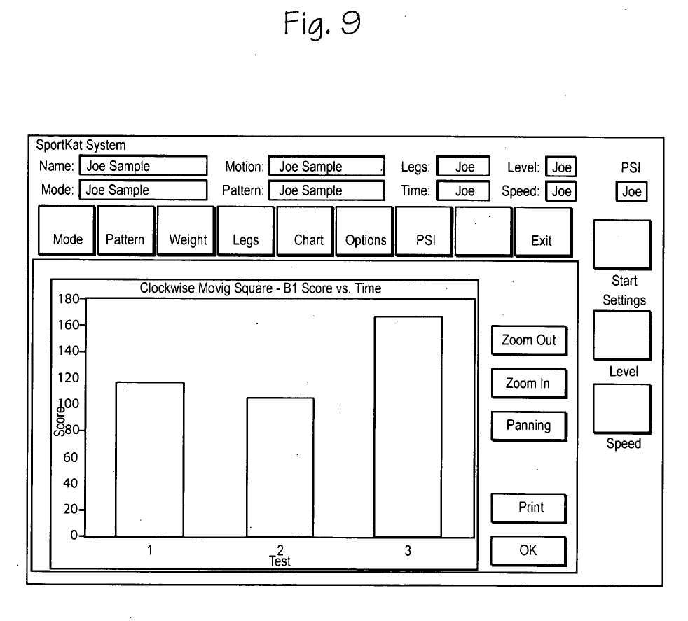

Once the interval is complete, the patient can view the results of the interval and compare it to previous interval sessions in order to note improvement. This is done by selecting the review mode. A representation of the graphs the patient views are illustrated in FIG. 9. A physician, therapist or patient viewing the report of FIG. 9 may review the data from previous sessions and compare it to more recent sessions in order to determine what amount of progress has been achieved. The data is presented in a bar graph that summarizes the score the patient received during each training session versus the time it took to achieve that score.

Balance training therapy for alleviation of symptoms associated with vestibular disorders requires many sessions. Daily treatment sessions, spread out over several weeks, best affect the success of the therapy. At least 20 to 30 daily treatment sessions should be completed. Each treatment session should last for between 15 to 20 minutes per session. At the completion of the 20 to 30 sessions. The patient is expected to have developed greatly improved motor coordination and improvement of symptoms associated with vestibular disorders. A treating physician or therapist can make a determination if a further course of treatment is necessary.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A method of moderating the symptoms of a vestibular disorder in a patient comprising:
providing a balance training system comprising a platform capable of sustaining the patient's body weight and adapted for the patient to stand atop the platform;
a tilt sensor operably connected to the unstable platform and capable of measuring the attitude of the platform as the patient moves atop the platform;
a monitor adapted for visual display of images to the patient; and
a control system operable to receive and record input from the tilt sensor and interpret the input as indicating the attitude of the platform and also capable of transmitting images to the monitor for the patient to view;
having the patient stand on top of the platform; and
having the patient view the monitor and manipulate the platform by shifting his or her weight in order to manipulate a graphical element on the display in response to prompts or graphic elements displayed on the monitor;
thereby moderating the symptoms of the vestibular disorder of the patient.

2. The method of claim 1 further comprising the steps of:
providing a platform plate supported by an inflatable bladder positioned beneath the balance platform and adapted to be inflated to support the platform.

3. The method of claim 2 further including the step of having the patient input the desired bladder pressure into the control system.

4. The method of claim 3 further including the step of having the patient select from a mode consisting of testing, review, maze, or training.

5. The method of claim 4 further including the step of having the patient select a foot pattern consisting of left foot only, right foot only, or both feet simultaneously.

6. The method of claim 5 further including the step of having a patient select from either a static or dynamic manner; wherein a static manner requires the patient to maintain the same body position continuously on the platform and the dynamic manner requires the patient to manipulate the platform by shifting the weight in his legs in a manner prompted by a cursor viewed by the patient on the monitor.

7. The method of claim 1 further comprising the step of programming the control system to provide the images to the monitor.

8. The method of claim 7 further comprising the step of having the patient operate the control system to provide images to the monitor and manipulate the images according to the platform attitude.

9. The method of claim 1 further comprising the step of having the patient engage in the method for a period of between 20 to 30 daily sessions wherein each daily session lasts for between 15 to 20 minutes.
